(19) United States
(12) Patent Application Publication
(10) Pub. No.: US 2005/0076142 A1
(43) Pub. Date: Apr. 7, 2005

(54) Automatic sub domain delegation of private name spaces for home-to-home virtual private networks

(76) Inventor: Kwan Wu Chin, Dulwich Hill (AU)

Correspondence Address: MOTOROLA, INC., 1303 EAST ALGONQUIN ROAD, IL01/3RD, SCHAUMBURG, IL, 60196, US

(21) Appl. No.: 10/666,598

(22) Filed: Sep. 19, 2003

(51) Int. Cl. G06F 15/16

(52) U.S. Cl. 709/245

(57) ABSTRACT

Methods, systems, and gateways are disclosed for attaching a private name space of a home network to a private name space of another home network. A name and an IP address of a remote home network are received via a virtual private network (VPN) tunnel coupling the remote home network and a local home network. The configuration of a DNS server of the local home network is updated to delegate the one or more names of the remote network to a remote gateway of the remote home network. A name and an IP address of the local home network are transmitted via the VPN tunnel to the remote home network. Methods, systems, and gateways are also disclosed for resolving a name request in a private name space of a home network with which a private name space of another home network is attached.

### FIELD OF THE INVENTION

The present invention relates generally to communications networks and in particular to home networks using gateways.

### BACKGROUND ART OF THE INVENTION

A virtual private network (VPN) is a set of interconnected private (or home) networks using a private address space, as defined in RFC1918, or a site-scoped IPv6 address. Each home network belongs to a private name space, for example “private.arpa” (or “local.arpa”) and also possibly one or more global domain names, for example “abc.xyz.com”. A gateway equipped with a domain name system (DNS) server, and possibly a DNS application level gateway (ALG), manages these domains.

Interconnecting one or more homes requires the synchronization of various network information, e.g., addresses and names. Consistency is required, so that users continue to access existing and remote services located in other homes without interruption. For example, if the domain name “toaster.private.arpa” is valid in two or more homes, users are unable to access the host toaster unambiguously, unless the users use the toaster's underlying IP address and provided that their IP addresses do not conflict. Moreover, renaming toaster to some other name causes inconvenience to users, who know the service by its previous name. This is especially a problem if the users have bookmarked the complete URL of the host.

Mechanisms have been proposed for establishing tunnels between two networks with the help of a third network. Such mechanisms assume that IP addresses and naming are manually configured after the VPN has been constructed.

Other mechanisms address VPN construction by discovering customer edge (CE) equipments that are part of a given VPN through a DNS. By querying the domain name, a CE is able to locate all CEs belonging to a given VPN, enabling the CE to form tunnels to other CEs belonging to a VPN. Customer edges in the same VPN belong to a well-known domain name (e.g., vpn1.vpn-net.net), and each CE registers its name in the DNS. To form a VPN, each CE queries the well-known domain name to obtain all IP addresses belonging to that domain. The CE then sets up a tunnel to each of the returned IP addresses.

Another mechanism proposes parsing a DNS request message to spread the load of resolving DNS names. The queried domain name is extracted and compared to a list of domain names. The destination address of the DNS request message is modified to the DNS server that is authoritative for the matching domain name. The modified DNS request message is then forwarded onwards to the new destination address.

### SUMMARY OF THE INVENTION

In accordance with an aspect of the invention, there is provided a method of attaching a private name space of a home network to a private name space of another home network. One or more names and one or more IP addresses of a remote home network are received via a virtual private network (VPN) tunnel coupling the remote home network and a local home network. The configuration of a DNS server of the local home network is updated to delegate the one or more names of the remote network to a remote gateway of the remote home network. One or more names and one or more IP addresses of the local home network are transmitted via the VPN tunnel to the remote home network.

The VPN tunnel between the remote home network and the local home network may be set up.

The method may further comprise the step of resolving any name conflicts in the local home network regarding the one or more names of the remote home network.

The method may further comprise the step of recording the one or more names and the one or more IP addresses of the remote home network.

The method may further comprise the step of sending a confirmation message to the remote gateway of the remote home network regarding the updating of the configuration of the DNS Server.

The method may further comprise the step of receiving either a confirmation message or a conflict message from the remote home network regarding the one or more names of the local home network transmitted to the remote home network. The method may further comprise the step of transmitting to the remote home network an alias for any one of the one or more names of the local home network for which a conflict message is received. Still further, the method may further comprise the step of updating information about any alias.

In accordance with another aspect of the invention, there is provided a method of resolving a name request in a private name space of a home network with which a private name space of another home network is attached. A DNS request is received in the home network. A determination is made if the DNS query is received from a virtual private network (VPN) tunnel coupling the home network with the other home network. If the DNS query is determined to have been received from the VPN tunnel, a reply is forwarded to a requesting host of the other home network in response to the DNS query.

The method may further comprise the step of determining if the queried name in the DNS request is a domain name of the home network. Further, the name may be resolved globally if the queried name in the DNS request is not a domain name of the home network.

The method may further comprise the step of transmitting the DNS query to one or more local name servers and receiving a reply from at least one of the local name servers. Further, the method may comprise the steps of determining if the queried name matches with alias information, and if a match is determined to exist, references to the real name mapping to the aliased name are removed from a DNS reply.

In accordance with yet another aspect of the invention, there is provided a gateway attaching a private name space of a home network to a private name space of another home network. The gateway comprises at least one communications interface for transmitting and receiving data, a storage unit for storing data and instructions to be carried out by a processing unit, and a processing unit coupled to the at least one communications interface and the storage unit. The processing unit is programmed to receive one or more names and one or more IP addresses of a remote home network via a virtual private network (VPN) tunnel coupling the remote home network and a local home network, to update the configuration of a DNS server of the local home network to delegate the one or more names of the remote network to a remote gateway of the remote home network, and to transmit one or more names and one or more IP addresses of the local home network via the VPN tunnel to the remote home network.

The processing unit may be programmed to set up the VPN tunnel between the remote home network and the local home network and to resolve any name conflicts in the local home network regarding the one or more names of the remote home network.

The processing unit may be programmed to receive either a confirmation message or a conflict message from the remote home network regarding the one or more names of the local home network transmitted to the remote home network.

The processing unit may be programmed to transmit to the remote home network an alias for any one of the one or more names of the local home network for which a conflict message is received.

The processing unit may be programmed to receive a DNS request in the home network, to determine if the DNS query is received from a virtual private network (VPN) tunnel coupling the home network with the other home network, and if the DNS query is determined to have been received from the VPN tunnel, to forward a reply to a requesting host of the other home network in response to the DNS query. Further, the processing unit may be programmed to determine if the queried name in the DNS request is a domain name of the home network. Also, the processing unit may be programmed to transmit the DNS query to one or more local name servers and to receive a reply from at least one of the local name servers, to determine if the queried name matches with alias information, and if a match is determined to exist, to remove references to the real name mapping to an aliased name from a DNS reply.

### BRIEF DESCRIPTION OF THE DRAWINGS

A small number of embodiments are described hereinafter with reference to the drawings, in which:

FIG. 1 is a block diagram illustrating home-to-home communications;

FIG. 2 is a block diagram illustrating DNS-related services within a residential gateway;

FIG. 3 is a block diagram illustrating a private name space at each home network in a virtual private network (VPN);

FIG. 4 is a diagram depicting an example of a zone file in the home network “kwan” of FIG. 3;

FIGS. 5(a) and 5(b) are block diagrams depicting examples of name conflicts;

FIG. 6 is a flow diagram illustrating a process of setting up sub-domains across two private networks;

FIG. 7 is a flow diagram illustrating a process of resolving a domain name request;

FIG. 8 is an example of a home network that can be practiced in the system of FIG. 1;

FIG. 9 is a block diagram illustrating the architecture of a gateway with which embodiments of the invention may be practiced;

FIG. 10 is a flow diagram illustrating a process of attaching a private name space of a home network to a private name space of another home network; and

FIG. 11 is a flow diagram illustrating a process of resolving a name request in a private name space of a home network with which a private name space of another home network is attached.

### DETAILED DESCRIPTION OF THE PREFERRED EMBODIMENT OF THE INVENTION

Methods, systems and gateways are disclosed for attaching a private name space of a home network to a private name space of another home network. In the following description, numerous specific details, including particular communications interfaces, network protocols, gateway hardware architectures and the like are set forth. However, from this disclosure, it will be apparent to those skilled in the art that modifications and/or substitutions may be made without departing from the scope and spirit of the invention. In other circumstances, specific details may be omitted so as not to obscure the invention. Where reference is made in any one or more of the accompanying drawings to steps and/or features, which have the same reference numerals, those steps and/or features have for the purposes of this description, the same function(s) or operation(s), unless the contrary intention appears.

Overview

The embodiments of the invention provide a method for automatically attaching a joining home network's name space to another home network's private name space (e.g., “private.arpa” or “local.arpa”) during virtual private network (VPN) formation. That is, the name spaces of the two home networks are intuitively and automatically linked when the home networks merge to form a VPN. The embodiments of the invention are able to negotiate a domain name for use within a VPN compatible with current DNS specifications in use on the Internet. Internal hosts are resolved, rather than CEs and GWs, i.e., host names are resolved after forming the VPN. Dynamic name allocation and maintenance schemes are employed to avoid name collisions. The domain name of a DNS request is looked up, and the request is sent to the appropriate DNS server. The embodiments of the invention do not modify the destination address of the DNS request message. Rather, another DNS request is emitted to the matching network that is authoritative for the queried domain name. The embodiments of the invention merge the private address name space of home networks. Users establishing a tunnel for home-to-home communications can access remote servers as if the services are local to their networks.

To set up a VPN, a local gateway (GW-local) connects to a remote gateway (GW-remote) to form the VPN. After ensuring that the IP addresses in both home networks do not collide, the GW-local provides the GW-remote with its home network name. If a home network name conflict is found, the user has an opportunity to offer a different name or an alias for use before the user can connect to the GW-remote.

An example of the joining process follows. The GW-local passes its home network's name (e.g., “kwan”) to the GW-remote. The GW-remote checks whether the name “kwan” is a sub-domain of the “private.arpa” name space or whether the name matches any hosts within its network. If not, the GW-remote informs the GW-local that the home network of the GW-local is allowed to join. Otherwise, a reject message is sent, and the GW-local prompts the user to correct the error. Besides the GW-local passing its name to the GW-remote, the GW-remote needs to pass its name to the GW-local, to be included in the private name space of the GW-local. Thus, the GW-local is able to access the hosts of the GW-remote by their names. A name conflict may occur if the GW-local has established a connection with another home network with a similar name or a device in the local network bears the same name. In this case, the GW-remote or the GW-local may suggest an alias to be used in the other remote home network. The embodiments of the invention use canonical name (CNAME) resource records (RR) to establish an alternative name for home networks experiencing name conflicts. Resource Records (RRs) are DNS data records, as defined in RFC 1035§3.2.1.

To delegate the DNS name space, each zone file of the private name space in both networks is augmented with name server (NS) RRs. An NS RR denotes the beginning of a DNS zone and supplies the domain name of a name server for the zone. After that, the GW-remote can access hosts that the GW-local manages by specifying <hostname>. “kwan.private.arpa”; this similarly applies for the GW-local, which can access the hosts of the GW-remote by specifying <hostname>.“foo.private.arpa”, given that “foo” is the GW-remote's home network name.

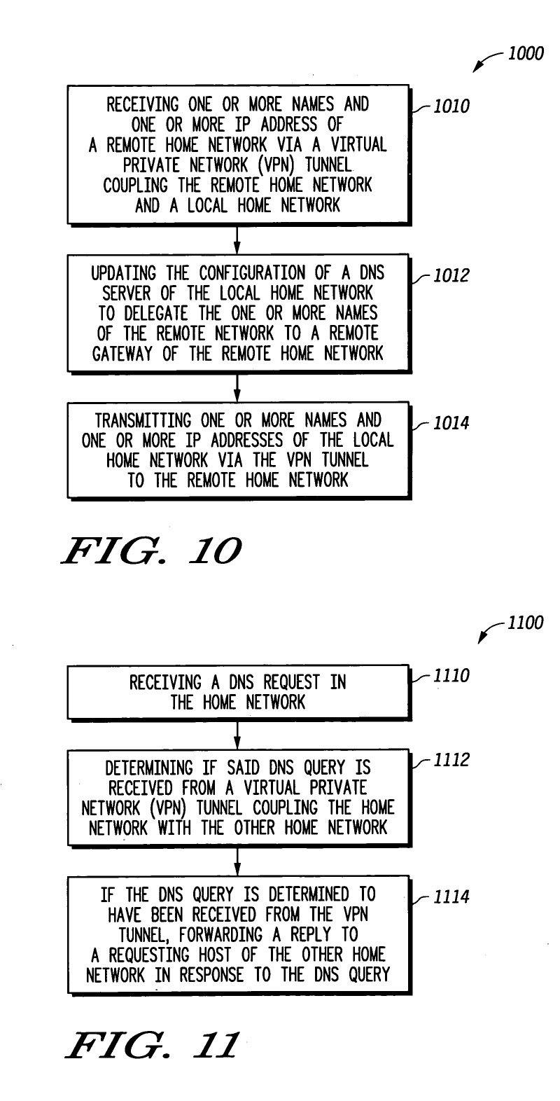

FIG. 10 is a flow diagram illustrating a process 1000 of attaching a private name space of a home network to a private name space of another home network. In step 1010, one or more names and one or more IP addresses of a remote home network are received via a virtual private network (VPN) tunnel coupling the remote home network and a local home network. In step 1012, the configuration of a DNS server of the local home network is updated to delegate the one or more names of the remote network to a remote gateway of the remote home network. In step 1014, one or more names and one or more IP addresses of the local home network are transmitted via the VPN tunnel to the remote home network. These steps and other details are described hereinafter.

FIG. 11 is a flow diagram illustrating a process 1100 of resolving a name request in a private name space of a home network with which a private name space of another home network is attached. In step 1110, a DNS request is received in the home network. In step 1112, a determination is made if the DNS query is received from a virtual private network (VPN) tunnel coupling the home network with the other home network. In step 1114, if the DNS query is determined to have been received from the VPN tunnel, a reply is forwarded to a requesting host of the other home network in response to the DNS query. Further details of the foregoing processes are set forth hereinafter.

Home-to-Home Communications

FIG. 1 is a high-level diagram illustrating communications between two or more home networks forming a VPN 100, with which embodiments of the invention may be practiced. Home network-A 110 and home network-B 160 are connected together to form a VPN. A VPN tunnel 120 conducts communications between the two networks 110, 160. The home network-A 110 comprises a server-A 112 coupled by suitable media 114 to a gateway-A (GW-A) 116. The server-A 112 may comprise one part of a local area network (LAN). For illustrative purposes only, the name of home network 110 (myhome-name) is “Kwan”. The other network 160 comprises a laptop computer 162 coupled by suitable media 164 to a gateway-B (GW-B) 166. Gateway-A 116 and gateway-B 166 are coupled together by the VPN tunnel 120. Each gateway 116, 166 has names, private.arpa and <myhome-name>.<global-domain-name>170. For illustrative purposes only, the name of home network 160 (myhome-name) is “Arthur”. While only two home networks are depicted, it will be understood that the VPN 100 may comprise more than two home networks.

It will be readily apparent to those skilled in the art that, in the light of this disclosure, numerous variations and substitutions may be made. For example, in FIG. 1, the server-A and the laptop computer are directly connected to the respective residential gateway. Either or both of the connections may be direct to the residential gateway. Alternatively, the connection may be by way of an Ethernet network using appropriate media cables. Another possibility is that the connection may be a wireless one, e.g., using IEEE 802.11a or IEEE 802.11b. Numerous other cable networks, wireless networks, or a combination of the two may be practiced. For example, a wireless device such as a PDA (e.g., a Palm Tungsten C) may be connected wirelessly to the server-A, which in turn may be coupled to the residential gateway by a cabled Ethernet network.

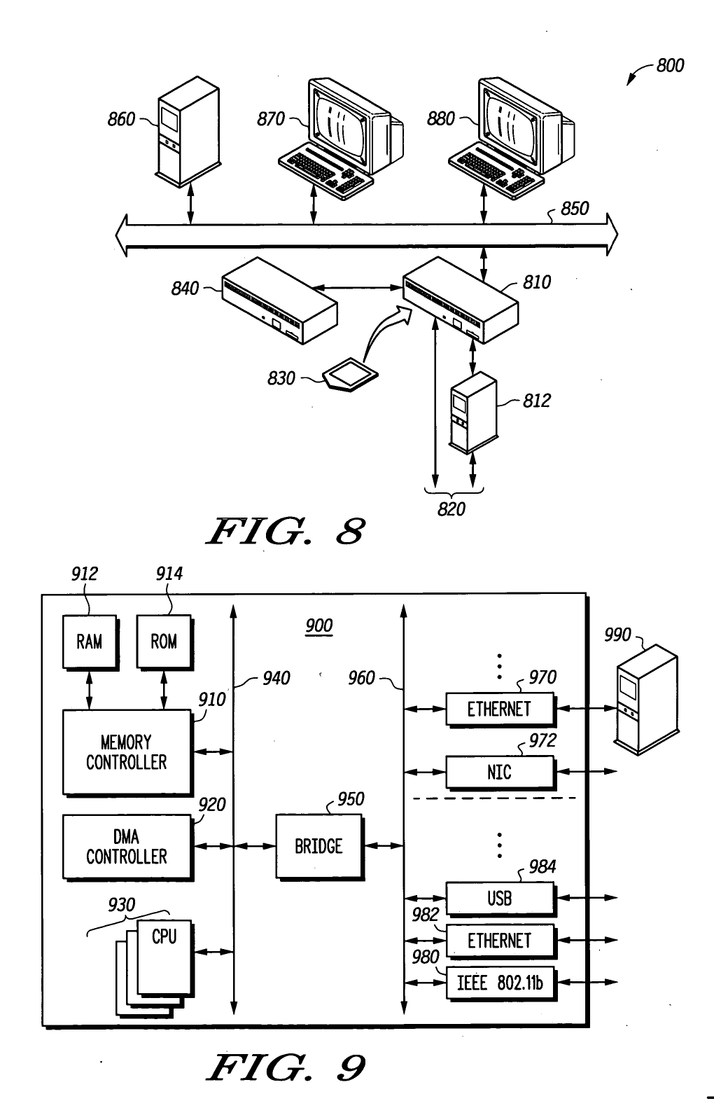

While FIG. 1 only shows a single host in each network, it will be readily appreciated by those skilled in the art that each home network may have two or more hosts. FIG. 8 is a block diagram of a home network 800 that may be practiced in FIG. 1 instead. The network 800 has a server 860 and two other computers 870 and 880 connected by an Ethernet network 850 to a gateway 810. The gateway 810 is also connected to a print server 840 and may be connected wirelessly to a PDA 830, for example. The gateway 810 may be connected by appropriate communications interface directly, or by a modem 812 indirectly to the remote home network, as indicated by connections 820. The foregoing is merely an example of the configuration of a home network and is not meant to be limiting to the embodiments of the invention.

Referring again to FIG. 1, the home network VPN 100 is created in a piece-wise fashion, in which a gateway (GW) 116, 166 can only connect to an established VPN if itself is not already on the VPN. After successfully connecting to the VPN, the gateway can accept connections from other gateways that are not connected to the VPN yet. Further, gateways in the VPN may form a mesh network where each GW maintains a separate tunnel to other gateways in the VPN. The VPN is formed this way to avoid problems associated with the merging of two disparate VPNs.

Each host 112, 162 in a home network 110, 160 belongs to the domain “private.arpa” (or “local.arpa”) and possibly a global domain name, such as “myhome.x.motlabs.mot.com”, in accordance with box 170 of FIG. 1. As part of the gateway installation process, a user enters the name of the home, i.e., “myhome” in the example above. In FIG. 1, examples of the name of the home are given as “Kwan” and “Arthur”. The home's name is prepended to the home's global domain name, if one exists, and is used by external users to access hosts within the home 110, 160, for example “server-A.kwan.x.motlabs.mot.com”. Each host 112, 162 in a home network 110, 160 is configured to forward all its DNS requests to the gateway 116, 166 and is configured to be in the “private.arpa” (or “local.arpa”) domain.

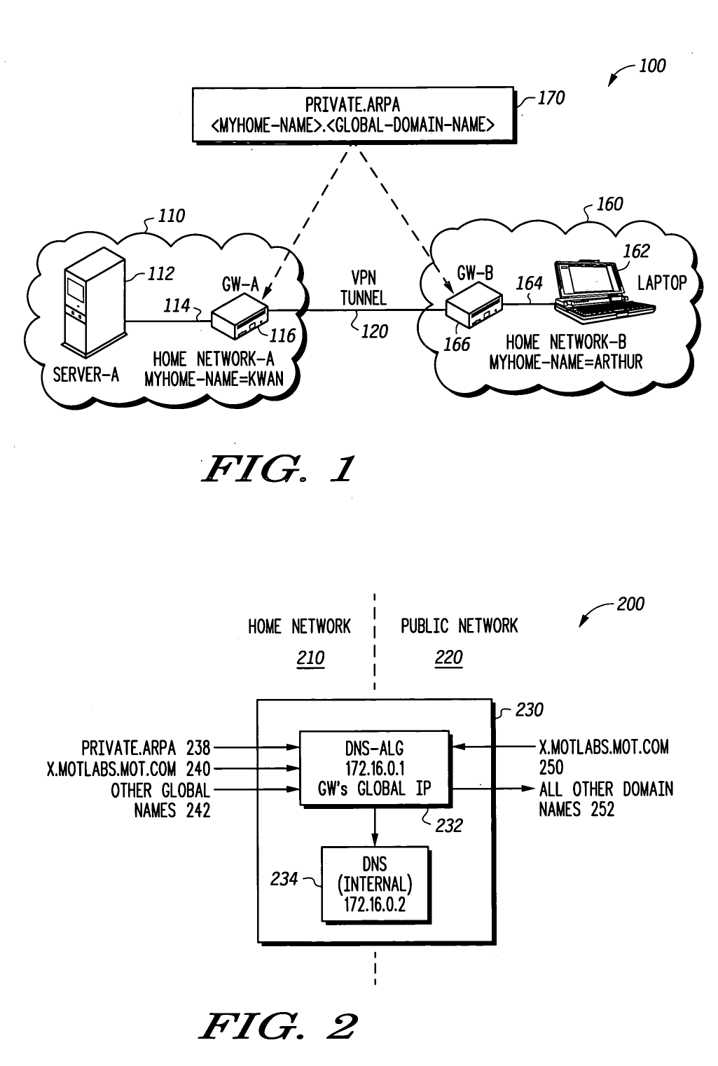

Each gateway 116, 166 is equipped with a DNS (not shown in FIG. 1, but see FIG. 2) to answer requests from hosts that are internal and external to the home network. Also, each gateway is authoritative for the “private.arpa” (or “local.arpa”) and is delegated at least part of the global domain name space. FIG. 2 illustrates the configuration 200 of a gateway 230 that may be practiced as gateway-A 116 and gateway-B 166 in FIG. 1. The gateway 230 bridges a home network 210 and a public network 220, which may be the Internet, for example. The gateway 230 comprises a DNS application level gateway (ALG) 232 that is both a resolver and an IPv4/IPv6 communication enabler. The DNS-ALG 232 has the gateway's global IP address (e.g., 172.16.0.1).

The DNS-ALG 232 may be implemented using a modification of Dan Bernstein's dnscache code, see http://cr.yp.to/djbdns.html. One of dnscache's features is the ability to redirect requests for a given domain name to one or more IP addresses. The DNS-ALG 232 interfaces with a DNS 234 with its own IP address (e.g., 172.16.0.2). To redirect DNS requests, a file may be created in the “server” directory with the global domain name (e.g., x.motlabs.mot.com), and the IP address of the servers that are authoritative for the domain are inserted into the file. The DNS-ALG 232 can receive the “private.arpa” (or “local.arpa”) names 238, global domain name 240 (e.g., x.motlabs.mot.com) and other global names 242 from the home network 210. Further, the DNS-ALG 232 can receive the global domain name 250 from the external public and provide other domain names 252 via the public network 220.

FIG. 9 illustrates an example of the hardware architecture that may be used to implement the gateway 230 of FIG. 2 and the gateways 116, 166 of FIG. 1.

Example of Gateway Architecture

FIG. 9 is a block diagram illustrating the architecture of a gateway 900 with which the embodiments of the invention may be practiced. The gateway 900 comprises one or more central processing units (CPUs) 930, a memory controller 910, and storage units 912, 914. The memory controller 910 is coupled to the storage units 912, 914, which may be random access memory (RAM), read-only memory (ROM), and any of a number of storage technologies well know to those skilled in the art. The CPU 930 and the memory controller 910 are coupled together by a processor bus 940. A direct-memory-access (DMA) controller 920 may also be coupled to the bus 940. The DMA controller 920 enables the transfer of data to and from memory directly, without interruption of the CPU 920. As shown in FIG. 9, the processor bus 940 serves as the memory bus, but it will be well understood by those skilled in the art that separate processor and memory buses may be practiced. Software to implement functionality of the gateway may be embedded in the storage unit, including an operating system, drivers, firmware, and applications. The CPU 930 functions as the processing unit of the gateway, however, other devices and components may be used to implement the processing unit.

A bridge 950 interfaces the processor bus 940 and a peripheral bus 960, which typically operates at lower data rates than the processor bus 940. Various communications interfaces are in turn coupled to the peripheral bus 960. For example, one or more of several communications interfaces may be practiced to connect devices in the home network to the gateway. The gateway 900 has as examples of such interfaces an IEEE 802.11b wireless interface 980, an Ethernet interface 982, and a Universal Serial Bus (USB) interface 984. The foregoing are merely examples and other network interfaces may be practiced, such as a Token Ring interface, other wireless LAN interfaces, and an IEEE 1394 (Firewire) interface. For connections external to the home network, other interfaces may be practiced. For example, the gateway 900 may have a network interface card 972 for connection to another network. Alternatively, the gateway 900 may comprise an Ethernet interface 970, which can be connected to a suitable modem 990 (e.g., a broadband modem). Still other network interfaces may be practiced including ATM and DSL, as examples of a few. The processes of attaching a private name space of a home network to a private name space of another home network and of resolving a name request in a private name space of a home network with which a private name space of another home network is attached may be implemented as software or computer programs carried out in conjunction with the processing unit and the storage unit(s) of the gateway.

While the gateway 900 has been depicted as a standalone device by itself, or in combination with a suitable modem, it will be well understood by those skilled in the art that the gateway may be implemented using a standard computer system with suitable software to implement the gateway functionality. Other variations may exist.

The embodiments of the invention make use of the fact that every home network is authoritative for a private domain name space such as “private.arpa” or “local.arpa”. The domain “private.arpa” (or “local.arpa”) is only restricted to hosts within the home network, but as a home network connects to another home network and forms a VPN, the “private.arpa” (or “local.arpa”) name space is extended to encompass hosts in the remote home network as well. Consequently, a home network can see a remote home network as part of its name space. Each home network manages its own “private.arpa” (or “local.arpa”) name tree, and networks planning to join together ask each other to be part of their respective private name space.

The embodiments of the invention retain existing naming conventions of existing devices. For example, if a user accesses the user's toaster by typing in “toaster.private.arpa” or “toaster”, the user is able to continue doing so and be sure that the hostname does not resolve to a remote network's toaster. On the other hand, if a user wants to access a remote network's host, the user specifies a domain name of the form “<host>.<home-net-name>” or “<host>.<home-net-name>.private.arpa”.

During the interconnection of home networks, users specify a name that is used to access their local hosts from the remote network. For example, a user may input the name of the user's home network. The remote network's GW (GW-remote) checks whether the GW-remote already has the specified name in its “private.arpa” (or “local.arpa”) name space. If a name conflict is found, the GW-remote rejects the join request, but otherwise sends its own name to the joining network. The joining network needs to check whether the name provided by the GW-remote conflicts with any existing names in its “private.arpa” name space. If there is no conflict, the GW-remote's name is added to the “private.arpa” name space.

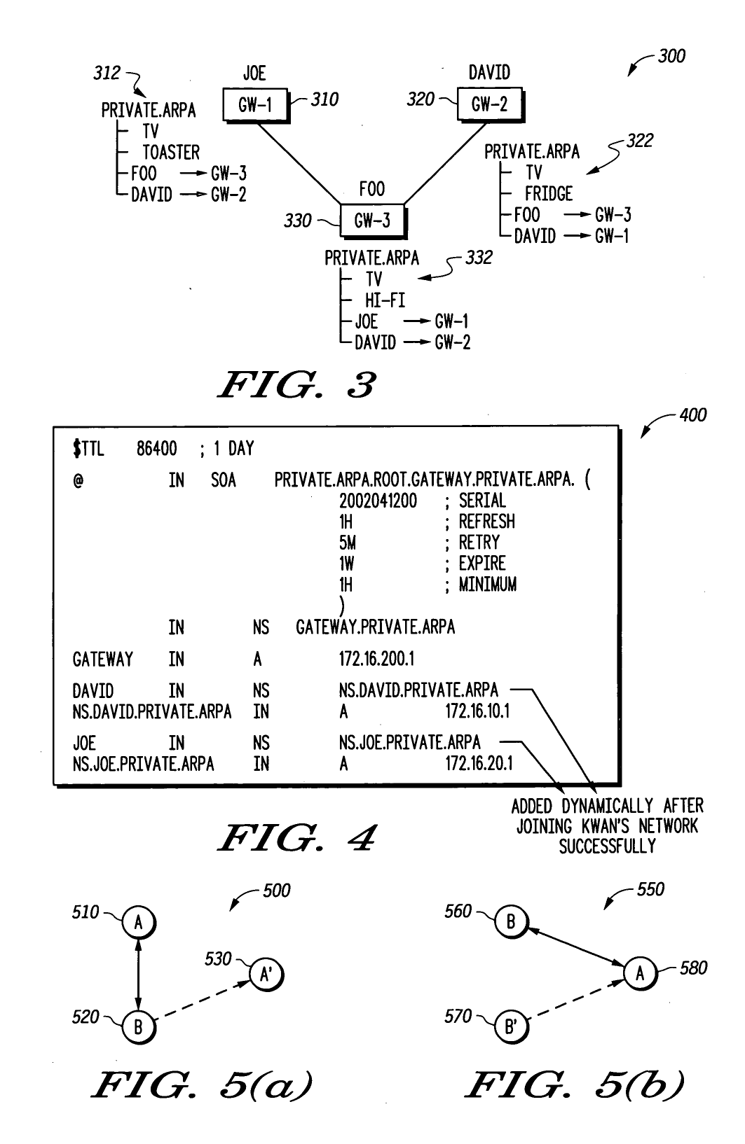

Care has to be taken that DNS queries for host names in one home do not propagate across the VPN, because there could be similar host names. FIG. 3 is a block diagram illustrating a private name space 312, 322, 332 at each home network 310, 320, 330 in a virtual private network (VPN) 300. The home network named “Joe” comprises GW-1 310, the home network named “David” comprises GW-2 320, and the home network named “Foo” comprises GW-3 330. Each private name space 312, 322, 332 is represented by a private.arpa name tree. The private.arpa name tree 312 comprises “Tv”, “Toaster”, “Foo”, and “David”. “Foo” points to the GW-3 330, and “David” points to the GW-2 320. The private.arpa name tree 322 comprises “Tv”, “Fridge”, “Foo”, and “Joe”. “Foo” points to the GW-3 330, and “Joe” points to the GW-1 310. The private.arpa name tree 332 comprises “Tv”, “Hi-Fi”, “Joe”, and “David”. “Joe” points to the GW-1 310, and “David” points to the GW-2 320. For example, in FIG. 3, the host name “Tv” is common to all three households (see the name trees 312, 322, 332).

Users in the “Foo” network 330 need to ensure that when those users want to access the “Tv” host, those users are referring to the local “Tv” host 332 and not “Tv” hosts 312, 322 in home networks “Joe” and “David” 310, 320. To reduce the chance of a name conflict, the “private.arpa” name space may be partitioned, so that the name “Joe”, “David”, “Foo” of each home network 310, 320, 330 is a sub-domain of “private.arpa”. For example, there may be a “Joe.private.arpa” domain and all hostnames within the home network “Joe” 310 belong to the “Joe.private.arpa” domain.

Join Process

After ensuring there are no IP address conflicts, the joining home network sends its home network's name to the other home network. Upon receiving the proposed name, the other GW checks for a name conflict by making a DNS query for “<proposed-name>.private.arpa”. If the query resolves successfully, the proposed name is in conflict with an existing host or sub-domain. Otherwise, the gateway returns a positive acknowledgement message.

In the case of a name conflict, the joining GW (or network) is asked to provide a different name. At this point, the joining GW may prompt the user for a different name before attempting to continue with the joining process. Apart from that, the other home network also offers to be part of the private name space of the joining network. The joining network also performs the same name conflict check as mentioned before. However, if there is a conflict, the user initiating the join may be asked for a conflict free name that maps to the remote network's name.

One embodiment of the joining process employs the Dynamic DNS Updates (RFC2136, 3007) mechanism. The GWs involved in the VPN forming process perform DNS updates on each other's DNS server. The IP address that the DNS server listens to at both ends is passed to each GW.

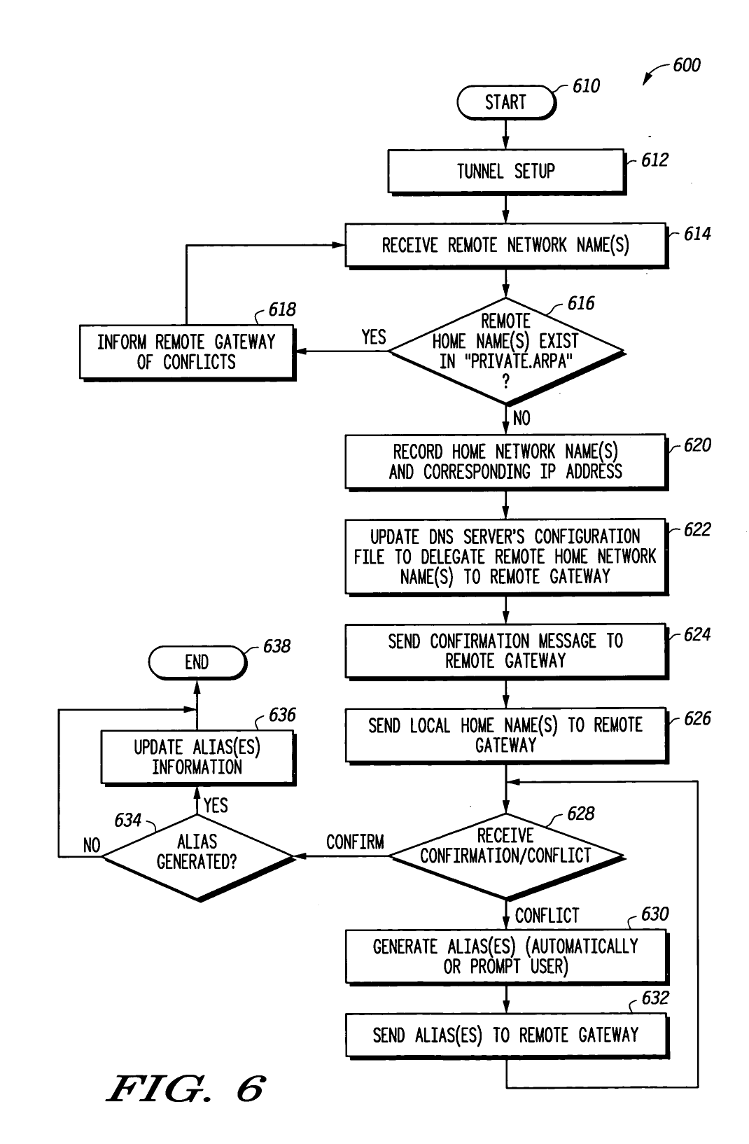

A process 600 of joining the name space of one home network to the name space of another home network is depicted in detail in FIG. 6. The flow diagram illustrates the setting up of sub-domains across two private networks. Processing commences in step 610. In step 612, a VPN tunnel is setup between the two networks. In step 614, the GW-local of the local network receives the name(s) of the remote network. In decision step 616, a check is made to determine if the received remote home network's name already exists in the private.arpa name tree of the GW-local of the local home network. As noted above, this may be done by the GW-local making a DNS query for “<proposed-name>.private.arpa” or by inspecting the DNS server's configuration file. If step 616 returns true (yes), meaning there is an already existing host name or sub-domain that conflicts, processing continues at step 618. In step 618, the remote gateway is informed of the conflict, where the GW-remote sends the GW-local a negative acknowledgement message. Processing then returns to step 614. As noted above, the GW-remote may be asked to provide another name. Otherwise, if decision step 616 returns false (no), processing continues at step 620.

In step 620, the GW-local records the name of the remote home network and its corresponding IP addresses (IPv4 private addresses or IPv6 site-scope addresses) of the remote home network's DNS server. In step 622, the GW-local updates the configuration file of the DNS server to delegate the name(s) of the remote home network to the GW-remote. In an embodiment using BIND's DNS server (see http://www.isc.org/products/BIND/), the file “/etc/namedb/named.conf” and associated files are updated to include the new domain delegation. The DNS server is then restarted after updating the relevant files. In step 624, the GW-local sends a confirmation message to the GW-remote. The GW-local is informed that there is no name conflict. The confirmation message may be a standard acknowledgement message. However, as an optimisation, an implementation may integrate step 624 into step 626. In step 626, the GW-local sends the name(s) of the local home network to the GW-remote. In decision step 628, a check is made to determine if the GW-local has received either a confirmation or a conflict message in reply from the GW-remote.

If a confirmation is received in step 628, processing continues at step 634. In step 634, the GW-local determines whether an alias has been generated to join the remote network. If so (Yes), step 636 is executed to update alias(es) information. Processing then ends in step 638. Otherwise, if step 634 returns false (No), the joining process ends in step 638. If decision step 628 returns that there is a conflict, processing continues at step 630. In step 630, one or more aliases are generated. The alias may be generated automatically, or manually by prompting the user. In step 632, the alias(es) is sent to the GW-remote, before processing continues at step 628. Complementary processing is carried out at both the GW-local and the GW-remote in line with the process 600 of FIG. 6 to effect the joining of the private address spaces of the two or more home networks.

Example of Name Resolution Between Home Networks

A user in a home network “kwan”, trying to access the host “tv” in a remote home network named “david”, only needs to type “tv.david”, assuming that the host “tv.kwan” has been configured with “private.arpa” as the default domain. A request for “tv.david.private.arpa” is emitted by the host that the user is on to the local gateway for resolution.

The DNS request is sent to the DNS running at the GW-local in the user's home network “kwan”. In this case, given that the domain “david” has been delegated to a different name server, the request is forwarded to the name server identified by the glue RR associated with the NS RR. A glue RR is the RR immediately following an NS RR that specifies the IP address of the name server that is authoritative for the delegated domain. This speeds up the lookup process, since the server does not need to perform another DNS query to find the authoritative server's IP address.

The DNS request is forwarded to the server running at IP address 172.16.10.1, referring to the zone file 400 shown in FIG. 4. At the GW of home network “david”, the DNS request is resolved successfully given that the host “tv” exists and the resulting IP address is returned to the requesting host at home network “kwan”. FIG. 4 shows an example configuration file 400 for BIND's DNS server named. The file specifies the authoritative server for the domain “private.arpa” to be “gateway.private.arpa”. The configuration file 400 in FIG. 4 also specifies two delegations for the domains “david” and “joe” each indicated by the keyword “NS”. The corresponding address of the server authoritative for both domains is specified in the RR right after their respective NS RR. These records are added or removed dynamically during tunnel set-up and teardown.

Name Conflict Resolution

A home network that already has a sub-domain beneath its “private.arpa” tree cannot join another network with a similar name. FIG. 5(a) illustrates a case 500 in which a node-B 520 already has an existing connection with a node-A 510. However, when the node-B 520 tries to establish a connection with another node-A′ 530 (dashed line connection), a name conflict occurs. A solution is for the node-B 520 to drop its existing connection to node-A 510, so that the node-B 520 can refer to the node-A′ 530 unambiguously.

Another similar case 550 is shown in FIG. 5(b). A node-B′ 570 tries to establish a connection with a node-A 580, which already has a connection with a node 560 named B. To resolve this ambiguity, the node-B′ 570 needs to be renamed before the node-B′ 570 can join the node-A's 580 network. However, it is possible that only uni-directional naming is done given that the node-B′ 570 has no problem referring to hosts in the node-A 580.

As mentioned, solutions to name conflicts include renaming connections, dropping existing connections, or refusing the join itself. Instead of renaming or dropping connections, a connecting gateway may be required to provide an alias to the remote home network of its home network's name. For example, in FIG. 5(b), the node-B 560 can connect to the node-A 580 and access hosts within the node-A 580 without ambiguity. Likewise, this applies for the node-B′ 570. However, for the node-A 580 to distinguish between the node-B′ 570 and the node-B 560, the node-B′ 570 needs to provide an alias to the node-A 580. Thereafter, the node-A 580 can access all hosts at the node-B′ 570 using the URL “<hostname>.<alias>.private.arpa”.

FIG. 5(a) depicts the other connection scenario. Given that the node-B 520 is trying to connect to a home network 530 with a similar name to one of its established home networks 510, the node-B 520 uses an “alias” for accessing the node-A′ 530.

Following from the above example shown in FIG. 5(b), the node-B 520 of FIG. 5(a) creates a NS RR with the alias of the node-A′ 530 and a glue RR containing the IP address of the node-A′ 530. The DNS server's configuration file at the node-A′ 530 is updated to include a CNAME RR containing the node-B 520's chosen alias. Note that the chosen alias must be unique in the node-A 530's network. The CNAME RR enables the node-A′ 530 to respond to any queries from the node-B 520, whereby the node-A′ 530 knows that a reference to the alias is a reference to the node-A′ 530.

At the node-B 520 due to the delegation to the node-A′ 530, any DNS requests for “<host>.<alias>.private.arpa” are forwarded to the node-A′ 530. At the node-A′ 530, the alias matches the aforementioned CNAME RR that in turn maps to the proper domain of the node-A′ 530 resulting in the return of the node-A′ 530's IP addresses. Before returning the DNS reply containing node-A′ 530's CNAME, real name, and IP addresses, the DNS-ALG removes the node-A′ 530's real name from the DNS reply, because the node-A′ 530's real name is ambiguous in the node-B's domain. Otherwise, the real name could map to a conflicting home network's DNS, in other words the node-A 510.

Resolving a Domain Name Request

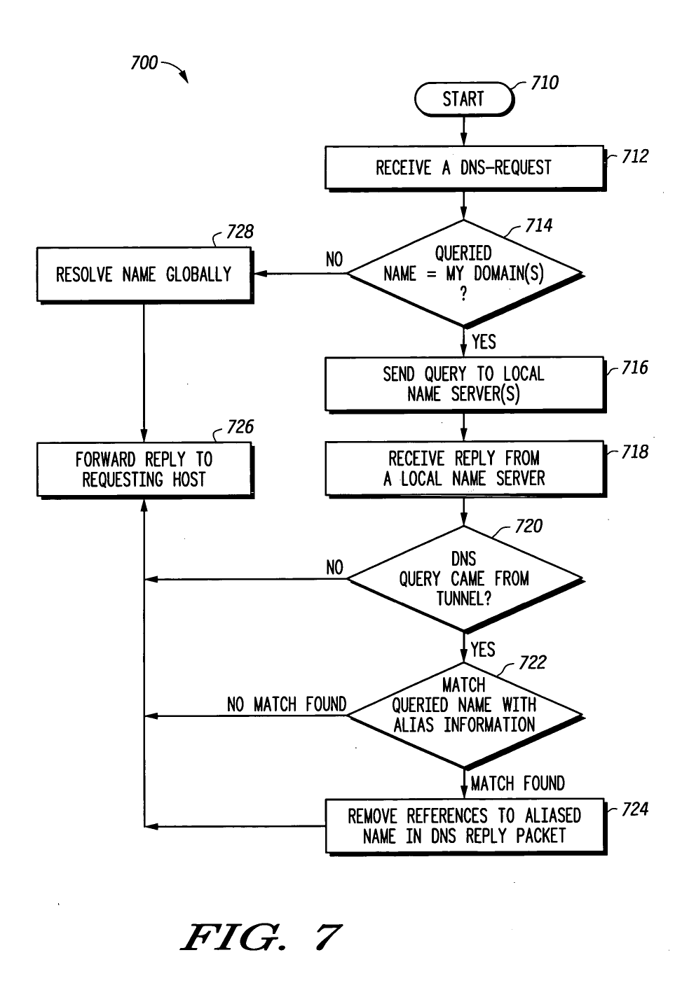

FIG. 7 is a flow diagram illustrating a process 700 of resolving a domain name request. Processing commences in step 710. In step 712, a GW-local receives a DNS request. In decision step 714, a check is made to determine if the queried name in the DNS request is the domain name of the home network (MyDomain(s)). If step 714 returns false (no), processing continues at step 728, in which the queried name is resolved globally as specified in RFC1034 and RFC1035. In step 726, the reply is forwarded to the requesting host from which the DNS request was received in step 712. Otherwise, if decision step 714 returns true (yes), processing continues at step 716.

In step 716, the DNS query is sent to the local name server(s). In step 718, a DNS reply is received from the local name server of step 716. In decision step 720, a check is made to determine if the DNS query came from a VPN tunnel. If decision step 720 returns false (no), processing continues at step 726, in which the reply is forward to the requesting host. Otherwise, if decision step 720 returns true (yes), processing continues at step 722. In step 722, a check is made to determine if the queried name matches with alias information. The alias information is stored at the gateway by the DNS-ALG, or the software establishing the VPN tunnel, or software that is used to establish naming between two homes. If no match is found, processing continues at step 726, in which the reply is forwarded to the requesting host. Otherwise, if a match is found in step 726, processing continues in step 724. In step 724, references to the real name mapping to an aliased name in the DNS reply packet are removed. Processing continues at step 726.

In the foregoing manner, a number of methods, systems, and gateways have been disclosed for attaching a private name space of a home network to a private name space of another home network. Also, methods, systems, and gateways have been disclosed for resolving a name request in a private name space of a home network with a private name space of another home network is attached.

The detailed description provides preferred exemplary embodiments only, and is not intended to limit the scope, applicability, or configuration of the invention. Rather, the detailed description of the preferred exemplary embodiments provides those skilled in the art with enabling descriptions for implementing preferred exemplary embodiments of the invention. It should be understood that various changes may be made in the function and arrangement of elements without departing from the spirit and scope of the invention as set forth in the appended claims.

1. A method of attaching a private name space of a home network to a private name space of another home network, said method comprising the steps of:
receiving one or more names and one or more IP addresses of a remote home network via a virtual private network (VPN) tunnel coupling said remote home network and a local home network;
updating the configuration of a DNS server of said local home network to delegate said one or more names of said remote network to a remote gateway of said remote home network; and
transmitting one or more names and one or more IP addresses of said local home network via said VPN tunnel to said remote home network.

2. The method according to claim 1, further comprising the step of setting up said VPN tunnel between said remote home network and said local home network.

3. The method according to claim 1, further comprising the step of resolving any name conflicts in said local home network regarding said one or more names of said remote home network.

4. The method according to claim 1, further comprising the step of recording said one or more names and said one or more IP addresses of said remote home network.

5. The method according to claim 1, further comprising the step of sending a confirmation message to said remote gateway of said remote home network regarding the updating of the configuration of said DNS Server.

6. The method according to claim 1, further comprising the step of receiving either a confirmation message or a conflict message from said remote home network regarding said one or more names of said local home network transmitted to said remote home network.

7. The method according to claim 6, further comprising the step of transmitting to said remote home network an alias for any one of said one or more names of said local home network for which a conflict message is received.

8. The method according to claim 7, further comprising the step of updating information about any alias.

9. A method of resolving a name request in a private name space of a home network with which a private name space of another home network is attached, said method comprising the steps of:
receiving a DNS request in said home network;
determining if said DNS query is received from a virtual private network (VPN) tunnel coupling said home network with said other home network; and
if said DNS query is determined to have been received from said VPN tunnel, forwarding a reply to a requesting host of said other home network in response to said DNS query.

10. The method according to claim 9, further comprising the step of determining if the queried name in said DNS request is a domain name of said home network.

11. The method according to claim 10, further comprising the step of resolving said name globally if the queried name in said DNS request is not a domain name of said home network.

12. The method according to claim 10, further comprising the steps of transmitting said DNS query to one or more local name servers and receiving a reply from at least one of said local name servers.

13. The method according to claim 12, further comprising the steps of:
determining if said queried name matches with alias information; and
if a match is determined to exist, removing references to the real name mapping to an aliased name from a DNS reply.

14. A gateway attaching a private name space of a home network to a private name space of another home network, comprising:
at least one communications interface for transmitting and receiving data;
a storage unit for storing data and instructions to be carried out by a processing unit;
a processing unit coupled to said at least one communications interface and said storage unit, said processing unit is programmed to:
receive one or more names and one or more IP addresses of a remote home network via a virtual private network (VPN) tunnel coupling said remote home network and a local home network,
update the configuration of a DNS server of said local home network to delegate said one or more names of said remote network to a remote gateway of said remote home network, and
transmit one or more names and one or more IP addresses of said local home network via said VPN tunnel to said remote home network.

15. The gateway according to claim 14, wherein said processing unit is programmed to set up said VPN tunnel between said remote home network and said local home network and to resolve any name conflicts in said local home network regarding said one or more names of said remote home network.

16. The gateway according to claim 14, wherein said processing unit is programmed to receive either a confirmation message or a conflict message from said remote home network regarding said one or more names of said local home network transmitted to said remote home network.

17. The gateway according to claim 16, wherein said processing unit is programmed to transmit to said remote home network an alias for any one of said one or more names of said local home network for which a conflict message is received.

18. The gateway according to claim 14, wherein said processing unit is programmed to receive a DNS request in said home network, to determine if said DNS query is received from a virtual private network (VPN) tunnel coupling said home network with said other home network, and if said DNS query is determined to have been received from said VPN tunnel, to forward a reply to a requesting host of said other home network in response to said DNS query.

19. The gateway according to claim 18, wherein said processing unit is programmed to determine if the queried name in said DNS request is a domain name of said home network.

20. The gateway according to claim 19, wherein said processing unit is programmed to transmit said DNS query to one or more local name servers and to receive a reply from at least one of said local name servers, to determine if said queried name matches with alias information, and if a match is determined to exist, to remove references to the real name mapping to an aliased name from a DNS reply.
